(19) United States
(12) Patent Application Publication
(10) Pub. No.: US 2025/0259809 A1
(43) Pub. Date: Aug. 14, 2025

(54) MODULAR SWITCHGEAR SYSTEM

(71) Applicant: G & W ELECTRIC COMPANY, Bolingbrook, IL (US)

(72) Inventors: William Tesch, Montgomery, IL (US); Nenad Uzelac, St John, IN (US); Kennedy Darko, Bolingbrook, IL (US); Andres Laso, Chicago, IL (US)

(21) Appl. No.: 19/054,231

(22) Filed: Feb. 14, 2025

Related U.S. Application Data
(60) Provisional application No. 63/553,473, filed on Feb. 14, 2024.

(51) Int. Cl. H01H 33/662; H01H 33/66; H01H 33/666

(52) U.S. Cl. CPC H01H 33/66207; H01H 33/6606; H01H 33/6661

(57) ABSTRACT

A switchgear system includes an enclosure containing atmospheric air and a loadbreak module disposed within the enclosure, the loadbreak module including a vacuum interrupter having a vacuum bottle enclosing a fixed contact and a movable contact, the movable contact movable along a first axis, and a sleeve surrounding the vacuum bottle. The loadbreak module further includes an interchange surrounded by a base housing, the interchange electrically connected to the movable contact, a first terminal surrounded by a first terminal housing, the first terminal electrically connected to the fixed contact, a second terminal electrically connected to the movable contact through the interchange, and a clamping assembly extending between the base housing and the first terminal housing. The vacuum interrupter is clamped between the first terminal housing and the base housing by the clamping assembly.

### CROSS-REFERENCE TO RELATED APPLICATIONS

This application claims priority to U.S. Provisional Patent Application No. 63/553,473, filed Feb. 14, 2024, the entire content of which is incorporated herein by reference.

### FIELD OF THE INVENTION

The present invention relates to electrical switchgear, and, more particularly, to electrical switchgear with modular components.

### BACKGROUND

Electrical switchgear is used to selectively open and close electrical connections in electrical power generation, transmission, and distribution systems. Gas-insulated electrical switchgear typically uses sulfur hexafluoride (SF6) contained within a tank to surround and insulate the high voltage components of the switchgear.

### SUMMARY

SF6 is a potent greenhouse gas, and a need has been identified to reduce the use of SF6 for insulating electrical switchgear. Switchgear systems embodying aspects of the present disclosure may be entirely insulated with solid dielectric insulation, eliminating the need to surround the switchgear system with SF6.

Switchgear systems are often produced and used in many different configurations to suit a particular location, load requirement, wiring arrangement, and the like. Forming (e.g., molding) the components of a solid dielectric insulated switchgear system can be costly, particularly if multiple different molds are required to form different configurations of the system. Accordingly, the present disclosure provides, among other aspects, a modular switchgear system allowing one or more parts of the switchgear system to be used in different configurations of the switchgear system.

For example, in some aspects, the techniques described herein relate to a switchgear system including: an enclosure containing atmospheric air; and a loadbreak module disposed within the enclosure, the loadbreak module including: a vacuum interrupter having: a vacuum bottle enclosing a fixed contact and a movable contact, the movable contact movable along a first axis, and a sleeve surrounding the vacuum bottle, an interchange surrounded by a base housing, the interchange electrically connected to the movable contact, a first terminal surrounded by a first terminal housing, the first terminal electrically connected to the fixed contact, a second terminal electrically connected to the movable contact through the interchange, and a clamping assembly extending between the base housing and the first terminal housing, wherein the vacuum interrupter is operable to selectively break or establish an electrical pathway between the first terminal and the second terminal in response to movement of the movable contact relative to the fixed contact, wherein the vacuum interrupter is clamped between the first terminal housing and the base housing by the clamping assembly.

In some aspects, the techniques described herein relate to a switchgear system, further including a first conductor coupled to the first terminal and a second conductor coupled to the second terminal, and wherein the first conductor and the second conductor are each surrounded by insulation.

In some aspects, the techniques described herein relate to a switchgear system, wherein the sleeve includes an outer sealing ridge and an inner sealing ridge, both sealing ridges positioned on an end of the sleeve adjacent the first terminal.

In some aspects, the techniques described herein relate to a switchgear system, wherein the sleeve is made of a resilient insulating material overmolded on the vacuum bottle.

In some aspects, the techniques described herein relate to a switchgear system, wherein the sleeve is compressed between the first terminal housing and the base housing.

In some aspects, the techniques described herein relate to a switchgear system, wherein the sleeve includes a plurality of external circumferential ribs.

In some aspects, the techniques described herein relate to a switchgear system, wherein the first terminal housing is made of a molded solid dielectric material.

In some aspects, the techniques described herein relate to a switchgear system, wherein the base housing is made of a molded solid dielectric material.

In some aspects, the techniques described herein relate to a switchgear system, wherein the clamping assembly includes a plurality of clamping members extending between the first terminal housing and the base housing, the clamping members applying a force to the first terminal housing and to the base housing to compress the sleeve between the first terminal housing and the base housing to form a first dielectric seal between the first terminal housing and the sleeve and to form a second dielectric seal between the base housing and the sleeve.

In some aspects, the techniques described herein relate to a switchgear system, wherein each clamping member includes a threaded stud made of fiberglass.

In some aspects, the techniques described herein relate to a three-phase switchgear system including the switchgear system, wherein the loadbreak module is a first loadbreak module, and wherein the three-phase switchgear system further includes: a second loadbreak module identical to the first loadbreak module corresponding to a second phase of the three-phase switchgear system; and a third loadbreak module identical to the first loadbreak module corresponding to a third phase of the three-phase switchgear system, wherein the first, second, and third loadbreak modules are disposed within the enclosure.

In some aspects, the techniques described herein relate to a switchgear system, wherein a first terminal assembly includes the first terminal and the first terminal housing, and wherein the first terminal assembly is interchangeable with a disconnect switch assembly.

In some aspects, the techniques described herein relate to a switchgear system for a power distribution system, the switchgear system including: a vacuum interrupter including an insulating sleeve and a vacuum bottle surrounded by the sleeve, the vacuum bottle enclosing a fixed contact and a movable contact; a first terminal assembly including a first terminal configured to be electrically connected to the fixed contact and a first terminal housing made of a molded solid dielectric material, the first terminal surrounded by the first terminal housing; and a base assembly including a base housing made of a molded solid dielectric material, an interchange supported within the base housing and configured to be electrically connected to the movable contact, and a second terminal electrically connected to the interchange; wherein the vacuum interrupter is operable to selectively break or establish an electrical pathway between the first terminal and the second terminal in response to movement of the movable contact relative to the fixed contact; and a disconnect switch assembly configured to be modularly interchangeable with the first terminal assembly.

In some aspects, the techniques described herein relate to a switchgear system, wherein the first terminal assembly, the vacuum interrupter, and the second terminal assembly are clamped together to provide a first dielectric seal between the first terminal housing and the sleeve and to provide a second dielectric seal between the second terminal housing and the sleeve.

In some aspects, the techniques described herein relate to a switchgear system, wherein the disconnect switch assembly, the vacuum interrupter, and the second terminal assembly are clamped together to provide a first dielectric seal between the disconnect switch assembly and the sleeve and to provide a second dielectric seal between the second terminal housing and the sleeve.

In some aspects, the techniques described herein relate to a switchgear system, wherein the disconnect switch assembly includes a housing, a rotor supported by the housing and including a contact bar, a line terminal, and an input terminal opposite the line terminal, wherein the input terminal is configured to be electrically connected to the fixed contact, and wherein the rotor is rotatable between a closed position, in which the contact bar electrically connects the line terminal and the input terminal, and an open position, in which the line terminal and the input terminal are electrically disconnected.

In some aspects, the techniques described herein relate to a switchgear system, wherein the housing of the disconnect switch assembly includes a plurality of dividing walls each sandwiched between a pair of sheds extending from a shaft portion of the rotor.

In some aspects, the techniques described herein relate to a method of manufacturing a switchgear system, the method including: providing a vacuum bottle enclosing a fixed contact and a movable contact, the movable contact movable along a first axis; surrounding the vacuum bottle with a sleeve to form a vacuum interrupter assembly; providing a first terminal assembly including a first terminal surrounded by a first terminal housing, the first terminal electrically connected to the fixed contact; providing a base assembly including an interchange and a second terminal both electrically connected to the movable contact, the interchange and the second terminal both surrounded by a base housing; and clamping the vacuum interrupter assembly between the first terminal housing and the base housing to form a loadbreak module.

In some aspects, the techniques described herein relate to a method, wherein surrounding the vacuum bottle with the sleeve includes overmolding the sleeve on the vacuum bottle.

In some aspects, the techniques described herein relate to a method, wherein the sleeve is made of a resilient insulating material.

Other features and aspects of the disclosure will become apparent by consideration of the following detailed description and accompanying drawings.

### BRIEF DESCRIPTION OF THE DRAWINGS

FIG. 1 is a perspective view of a switchgear system according to an embodiment of the present disclosure.

FIG. 2 is a cross-sectional view of the switchgear system of FIG. 1 taken along line 22 in FIG. 1.

FIG. 3 is a perspective view of a loadbreak module of the switchgear system of FIG. 1.

FIG. 4 is a cross-sectional view of the loadbreak module of FIG. 3, taken along line 44 in FIG. 3.

FIG. 5 is a cross-sectional view of the loadbreak module of FIG. 3, taken along line 55 in FIG. 3.

FIG. 6 is a perspective view of a first terminal of the loadbreak module of FIG. 3.

FIG. 7 is a bottom view of the first terminal of FIG. 6.

FIG. 8 is a perspective view of a vacuum interrupter assembly of the loadbreak module of FIG. 3.

FIG. 9 is a perspective view of a base assembly of the loadbreak module of FIG. 3, including a second terminal.

FIG. 10 is a side view of the loadbreak module of FIG. 3.

FIG. 11 is perspective view illustrating another embodiment of the switchgear system of FIG. 1.

FIG. 12 is a perspective view of the switchgear system of FIG. 11, with portions hidden.

FIG. 13 is a partially exploded perspective view illustrating a disconnect switch assembly of the switchgear system of FIG. 11.

FIG. 14 is an exploded perspective view of the disconnect switch assembly of FIG. 13.

FIG. 15 is a schematic view of a terminal assembly according to another embodiment and which may be used with the switchgear systems of FIGS. 1 and 11.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Also, it is to be understood that the phraseology and terminology used herein is for the purpose of description and should not be regarded as limiting. For example, the use of directional terms such as upper, lower, top, bottom, left, and right are used for descriptive purposes only with reference to the particular orientations illustrated in the figures.

### DETAILED DESCRIPTION

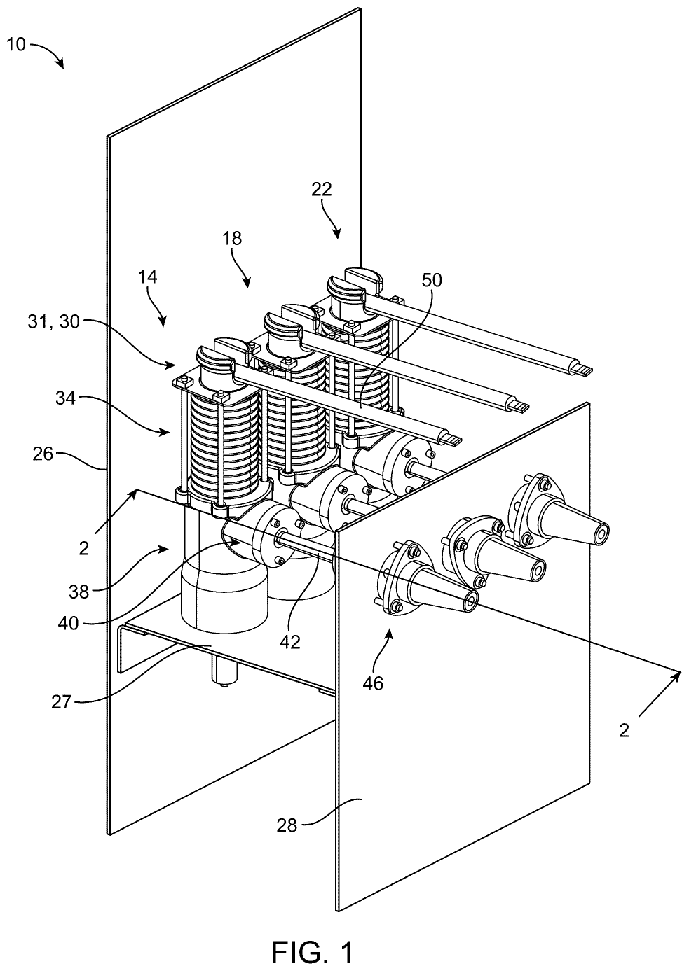

FIGS. 1-15 illustrate embodiments of a switchgear system 10. The illustrated switchgear system 10 is a three-phase switchgear system 10 that is configured for use in a three-phase power distribution system. The switchgear system 10 may be a medium-voltage switchgear system for electrical power distribution/segmentation at maximum voltages up to, for example, 15.5 kilovolts (“kV”), 15 kV, 27 kV, 38 kV, etc. and continuous currents of up to, for example, 200 Amps (“A”), 300 A, 400 A, 500 A, 600 A, 800 A, 900 A, etc. in certain embodiments. As described in greater detail below, the switchgear system 10 includes components with high performance solid-dielectric insulation, allowing the components to be contained within a compact enclosure but without the need for the enclosure to be filled with sulfur hexafluoride (SF6) insulating gas, which is a potent greenhouse gas increasingly subject to government regulations.

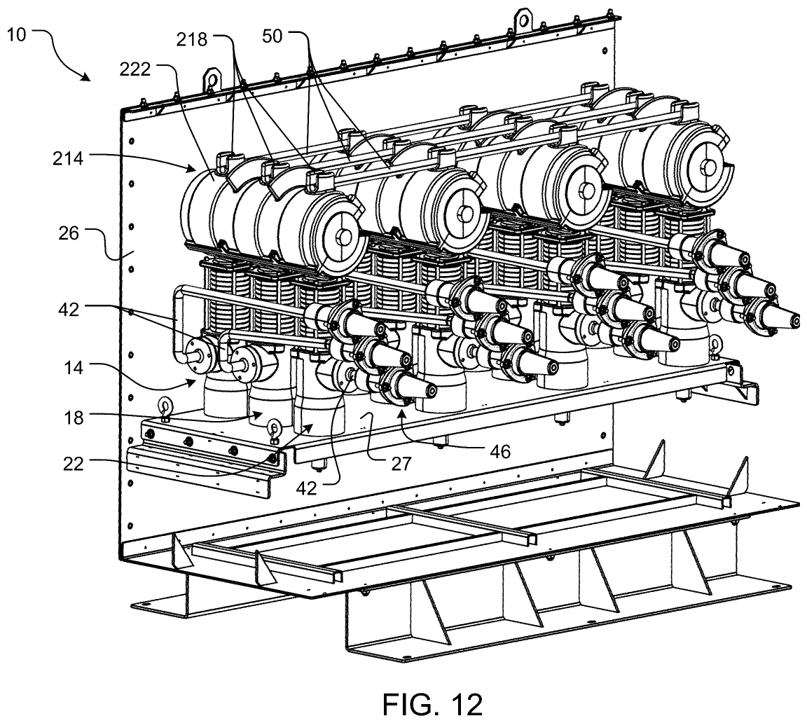

With reference to FIGS. 1, 11, and 12, the illustrated switchgear system 10 includes a plurality of loadbreak modules 14, 18, 22 supported on a shelf 27 within an enclosure 26 (only a portion of which is illustrated in FIGS. 1 and 12). In some embodiments, the enclosure 26 contains atmospheric air, and in such embodiments, the enclosure 26 may not be hermetically sealed. In other embodiments, the enclosure may contain a non-SF6 insulating gas, including but not limited to a natural origin gas such as carbon dioxide. In yet other embodiments, the enclosure 26 may be omitted.

The loadbreak modules 14, 18, 22 each correspond with a respective phase of the three-phase power distribution system and are otherwise identical. As such, details of the loadbreak modules 14, 18, 22 are described herein with reference to the loadbreak module 14. In some embodiments (e.g., FIG. 12), the switchgear system 10 may include multiple “ways” or rows, each containing three loadbreak modules 14, 18, 22. For example, the switchgear system 10 illustrated in FIG. 12 includes four rows of three loadbreak modules 14, 18, 22, such that the switchgear system 10 is a four-way switchgear system with twelve total loadbreak modules 14, 18, 22. In other embodiments, the switchgear system 10 may be configured as a single-way system (as shown in FIG. 1), a two-way system, a three-way system, a five-way system, or a system with any other desired number of ways. In yet other embodiments, the switchgear system 10 may be configured as a single-phase switchgear system with one or more ways each containing only a single loadbreak module (e.g., loadbreak module 14).

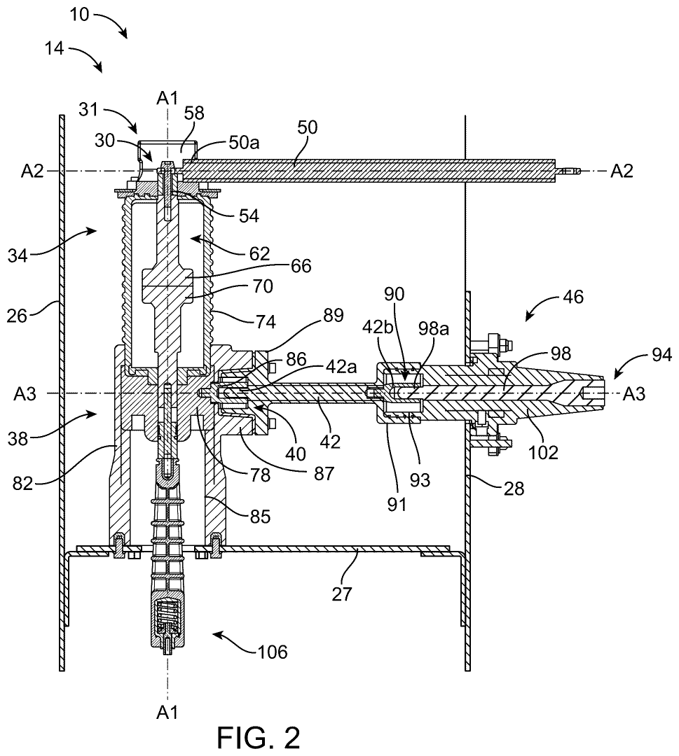

Referring now to FIG. 2, the illustrated loadbreak module 14 includes a first terminal 30, a vacuum interrupter assembly 34, and a base assembly 38 including a second terminal 40. The first terminal 30 and the second terminal 40 are configured to be mechanically and electrically connected to a first conductor 50 (e.g., a supply-side conductor) and a second conductor 42 (e.g., a load-side conductor), respectively. The illustrated first conductor 50 and second conductor 42 are each covered with an insulator (e.g., a silicone or rubber sleeve or coating, a molded epoxy, or the like). As described in greater detail below, the first terminal 30, the vacuum interrupter assembly 34 and the base assembly 38 are coupled (e.g., clamped) together to form the loadbreak module 14, which is operable to selectively break and establish an electrical connection between the first terminal 30 and the second terminal 40 (and thus, between the first conductor 50 and the second conductor 42).

With continued reference to FIG. 2, in the illustrated embodiment, the first terminal 30 includes a conductive lug 54 that connects the vacuum interrupter assembly 34 to the first conductor 50. The first terminal 30 is surrounded by a first terminal housing 58 such that the first terminal 30 and first terminal housing 58 form a first terminal assembly 31. The first terminal housing 58 is an electrical insulator (e.g., a solid dielectric material such as epoxy) and may, in some embodiments, be molded as a single, unitary body.

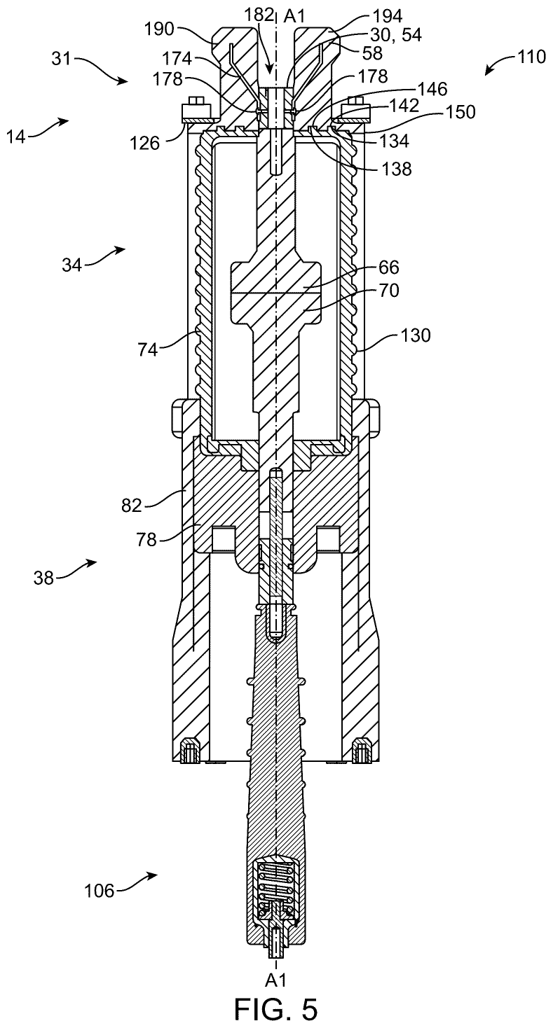

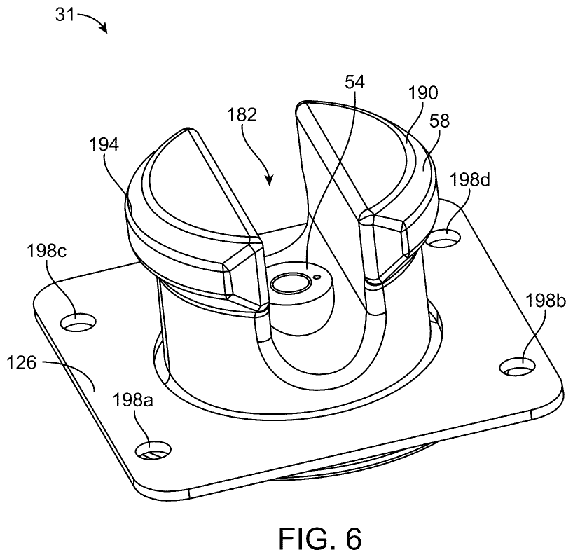

With reference to FIG. 5, a conductive shield 174 is molded within the first terminal housing 58 and affixed to the conductive lug 54 by fasteners 178. Referring to FIG. 6, the first terminal housing 58 includes a first upstanding portion 190 and an opposite second upstanding portion 194. A U-shaped recess 182 is defined between the upstanding portions 190, 194. The conductive lug 54 is positioned within the recess 182, and the recess 182 is sized and shaped to receive an end portion 50a of the first conductor 50 (FIG. 2), such that the connection between the conductive lug 54 and the first conductor 50 is disposed entirely within the recess 182. The shape of the first terminal housing 58 and the embedded shield 174 provides electrical stress reduction in the region of the conductive lug 54.

Returning to FIG. 2, the illustrated vacuum interrupter assembly 34 includes a vacuum bottle 62 that encloses a fixed contact 66 and a movable contact 70. The fixed contact 66 is electrically connected to the conductive lug 54. The movable contact 70 is movable along a first axis A1 between a closed position, shown in FIG. 2, in which the movable contact 70 engages the fixed contact 66, and an open position (not shown), in which the movable contact 70 is spaced apart from the fixed contact 66. The vacuum interrupter assembly 34 further includes an overmolded electrical insulator, such as a sleeve 74, that surrounds the vacuum bottle 62. In the illustrated embodiment, the sleeve 74 is made of a resilient and flexible dielectric material, such as silicone or rubber. In some embodiments, the sleeve 74 may be formed separately and then applied to the outer surface of the vacuum bottle 62. The base assembly 38 includes an interchange 78 made of an electrical conductor. The interchange 78 is electrically connected to the movable contact 70 and allows the movable contact 70 to move longitudinally along the first axis A1 within the interchange 78.

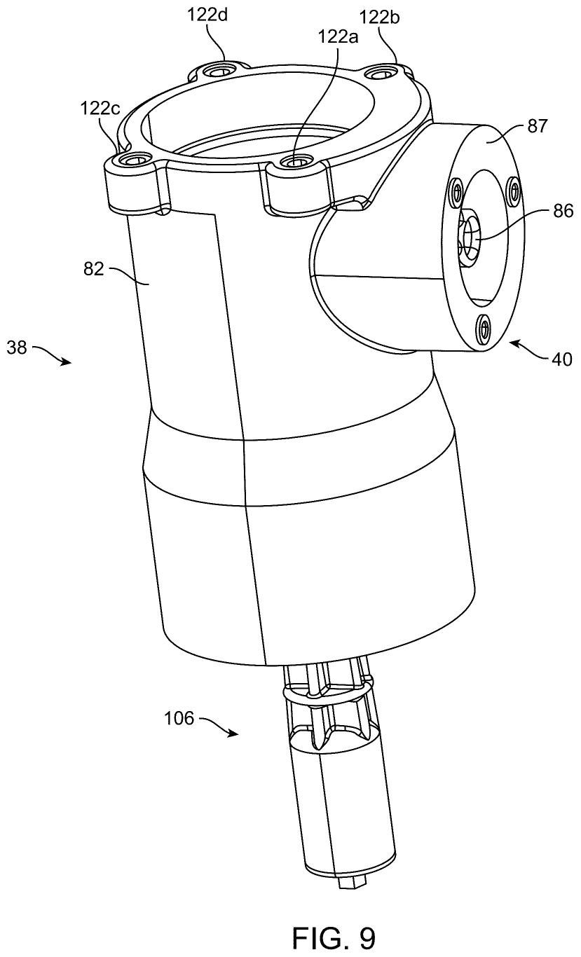

With reference to FIGS. 2 and 9, the base assembly 38 further includes a body or base housing 82 and a second terminal housing 87, which, in the illustrated embodiment, is an integral portion of the base housing 82. The illustrated base housing 82 is an electrical insulator (e.g., a solid dielectric material such as epoxy) and may, in some embodiments, be molded as a single unitary body. A cavity 85 in the base housing 82 below the interchange 78 receives an operating rod 106, which couples the movable contact 70 to a loadbreak actuator (e.g., an electromagnetic actuator, a manual actuating handle, or any other suitable actuator; not shown) located below the shelf 27. The loadbreak actuator is operable to move the movable contact 70 along the first axis A1 between its open and closed positions to selectively break and establish an electrical connection between the first terminal 30 and the second terminal 40. The loadbreak actuator may be, for example, the loadbreak actuator mechanism described and illustrated in U.S. patent application Ser. No. 17/543,363, filed Dec. 6, 2021, in the name of G & W Electric Company (“the G & W Application”), the entire content of which is incorporated herein by reference. In some embodiments, the loadbreak actuator is configured such that the three loadbreak modules 14, 18, 22 for each way of the switchgear system 10 are actuated together.

With reference to FIG. 2, the first terminal assembly 31 in the illustrated embodiment is configured such that the first conductor 50 extends along a second axis A2 perpendicular to the first axis A1. The second terminal housing 87, which is annularly shaped, extends along a third axis A3 perpendicular to the first axis A1 and parallel to the second axis A2. In other embodiments, the axes A1, A2, A3 may be oriented differently. For example, the first terminal assembly 31 may be arranged such that the axis A2 of the first conductor 50 extends perpendicular to the axis A3 of the second conductor 42.

In the illustrated embodiment, the second terminal 40 includes a female connector 86 (e.g., a tulip connector) received within the second terminal housing 87 and connected to (e.g., threaded into) the interchange 78. The female connector 86 is configured to receive a male portion 42a of the second conductor 42 to electrically connect the second conductor 42 with the interchange 78 and thus, with the movable contact 70. In other embodiments, other types of connectors may be used to electrically connect the second conductor 42 with the interchange 78. For example, the second conductor 42 may include the female connector 86, and the second terminal 40 may include the male portion 42a.

With continued reference to FIG. 2, the insulation surrounding the second conductor 42 includes a flange 89 in the illustrated embodiment, which is coupled to an outer face of the second terminal housing 87 (e.g., by a plurality of fasteners, which may be insulated fasteners in some embodiments). The flange 89 and the outer terminal housing 87 thus cooperate to fully enclose and insulate the interface of the connectors 42a, 86. In some embodiments, a compressible resilient seal (e.g., a silicone seal) may be provided between the flange 89 and the second terminal housing 87 to further insulate the interface. In some embodiments, the second conductor 42 and the second terminal housing 87 may include other cooperating geometries to enclose and insulate the interface of the connectors 42a, 86.

In the illustrated embodiment, the second conductor 42 is connected to a bushing assembly 46 that is affixed to the enclosure 26 to provide electrical access to a voltage of the second conductor 42 from an exterior of the enclosure 26 (and through, for example, a front panel 28 of the enclosure 26). The second conductor 42 electrically connects the second terminal 40 to an inner terminal 90 of the bushing assembly 46. For example, in the illustrated embodiment, the second conductor 42 includes a female connector 42b (e.g., a tulip connector) opposite the male portion 42a. The bushing assembly 46 includes an internal conductor 98 (i.e., a third conductor) with a male portion 98a received by the female connector 42b of the second conductor 42. In other embodiments, other types of connectors may be used to electrically connect the second conductor 42 to the internal conductor 98 of the bushing assembly 46.

With continued reference to FIG. 2, the insulation surrounding the second conductor 42 includes a cup-shaped end 91 in the illustrated embodiment, which surrounds a cup-shaped end 93 of an insulating body 102 of the bushing assembly 46. The flange two cup-shaped ends 91, 93 face each other and cooperate to fully enclose and insulate the interface of the connectors 42b, 98a. In some embodiments, one or more a compressible resilient seals (e.g., a silicone o-ring seal) may be provided between the outer surface of the cup-shaped end 93 and the inner surface of the cup-shaped end 91 to further insulate the interface between the two connectors 42b, 98a. In some embodiments, the insulating body 102 and the second conductor 42 may include other cooperating geometries to enclose and insulate the interface of the connectors 42b, 98a.

The internal conductor 98 of the bushing assembly 46 electrically connects the inner terminal 90 to an outer terminal 94 of the bushing assembly 46. The third conductor 98 extends through the front panel 28 of the enclosure 26, and the insulating body 102 of the bushing assembly 46 electrically insulates the conductive components of the bushing assembly 46 from the enclosure 26, such that the enclosure 26 is a “dead front” enclosure 26. The bushing assembly 46 is mounted to the enclosure 26 such that the outer terminal 94 is accessible from an exterior of the enclosure 26 to connect, for example, an electrical cable.

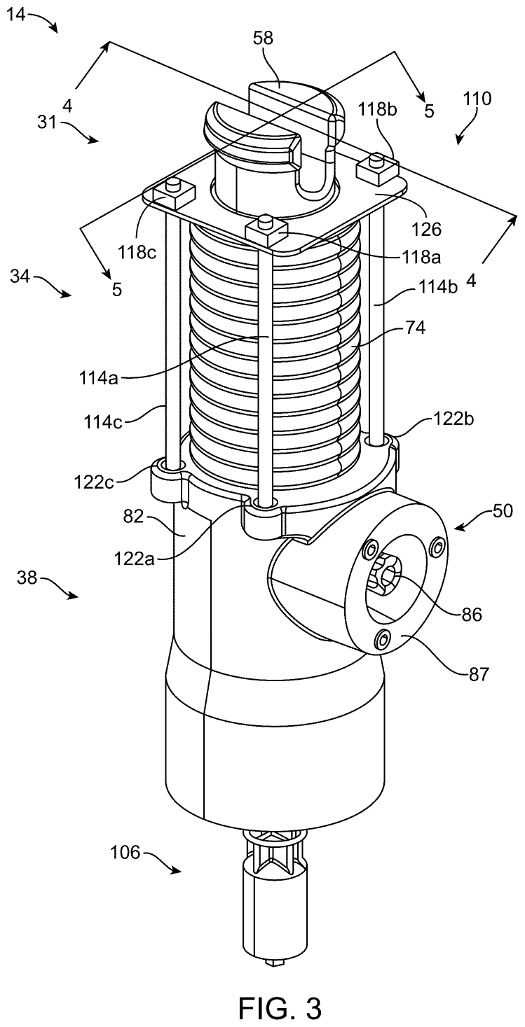

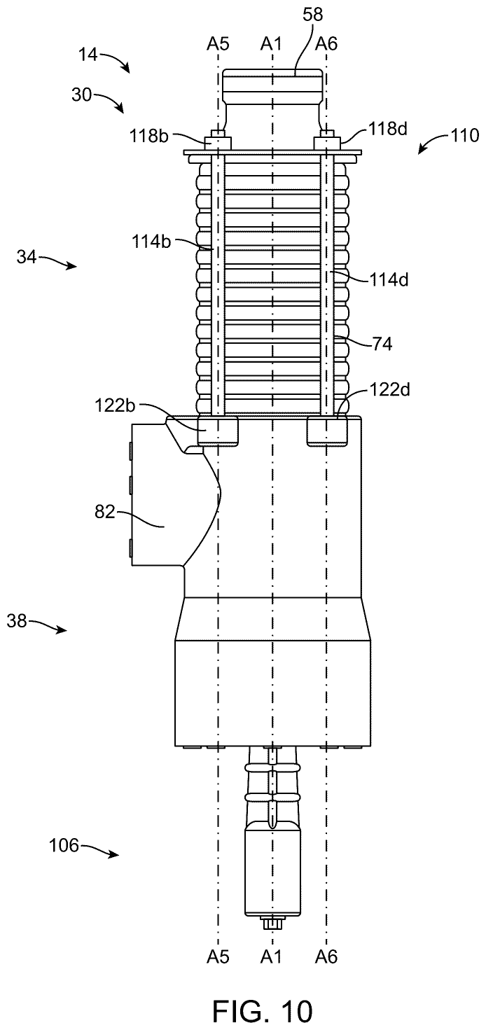

With reference to FIGS. 3 and 10, a clamping assembly 110 fixes together the first terminal assembly 31, the vacuum interrupter assembly 34, and the base assembly 38. The clamping assembly 110 may include a variety of clamping mechanisms to clamp the first terminal assembly 31, the vacuum interrupter assembly 34, and the base assembly 38. In the illustrated embodiment, the clamping assembly 110 includes a plurality of (and more specifically, four) clamping members 114a, 114b, 114c, 114d, shown in the illustrated embodiment as threaded clamping rods or studs. The clamping rods 114a-d are made of an insulating material such as fiberglass. With reference to FIG. 10, each clamping member 114a, 114b, 114c, 114d extends along and defines a respective clamping axis (e.g., the clamping member 114b defines the clamping axis A5, and the clamping member 114d defines the clamping axis A6). In the illustrated embodiment, the first axis A1 is parallel to the clamping axes A5, A6.

Referring again to FIGS. 3 and 10, a first end of each clamping rod 114a-d connects to a nut 118a, 118b, 118c, 118d provided adjacent the first terminal assembly 31, and a second end or head of each clamping rod 114a-d is received by and engages a receptacle 122a, 122b, 122c, 122d provided in the base housing 82. With reference to FIGS. 3-7 and 10, the clamping rods 114a-d extend through holes 198a, 198b, 198c, 198d in a plate 126 provided around the first terminal housing 58 such that the nuts 118a-d are engageable with the plate 126 to transmit an axial clamping force from the clamping rods 114a-d to the first terminal housing 58. The plate 126 is made of an insulating material such as fiberglass, and may be made of the same material as the clamping rods 114a-d. Clamping the first terminal housing 58 against the sleeve 74 and clamping the base housing 82 against the sleeve 74 provides respective dielectric seals between the respective components, as described in greater detail below, as the sleeve 74 is compressed between the first terminal housing 58 and the base housing 82.

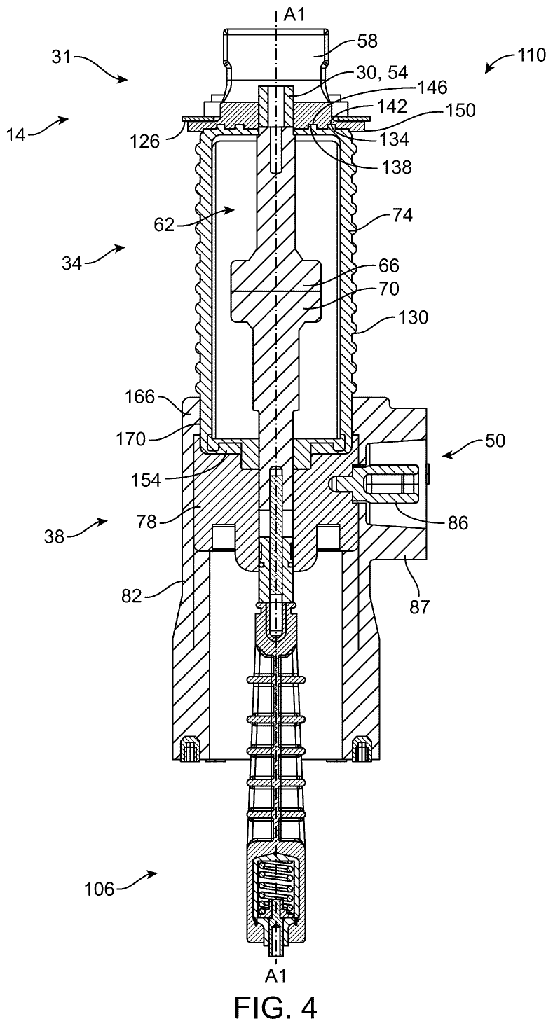

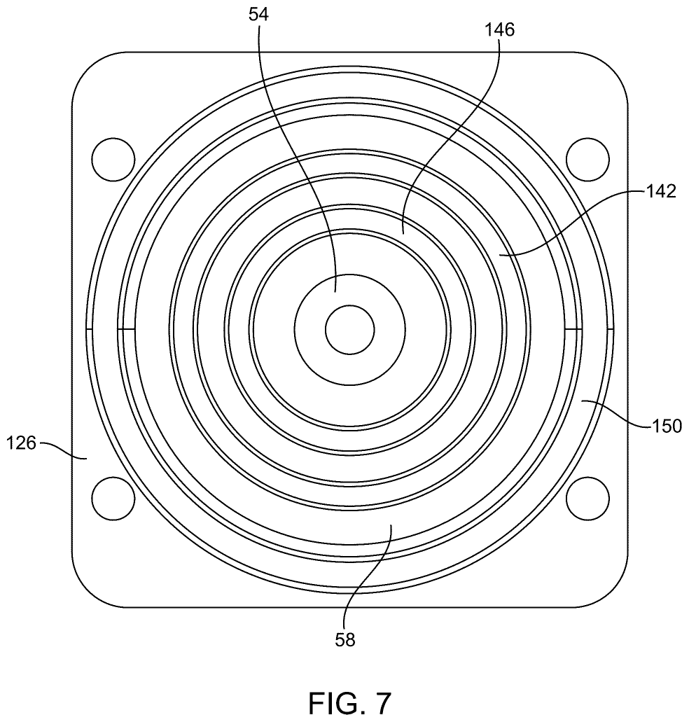

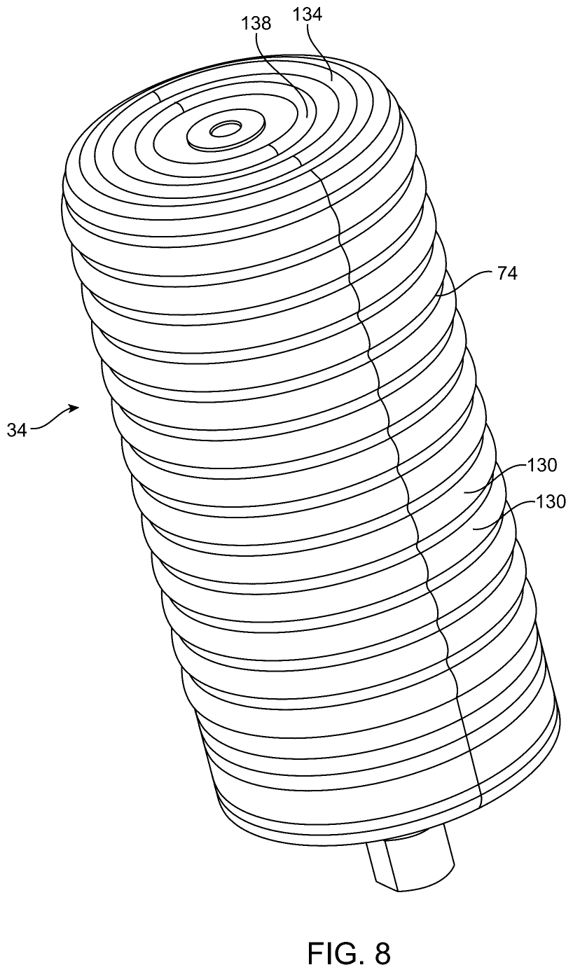

With reference to FIG. 8, the illustrated sleeve 74 includes a plurality of external circumferential sheds 130 surrounding the sleeve 74, such that the sleeve 74 has an undulating outer profile. The sleeve 74 includes an outer sealing ridge 134 and an inner sealing ridge 138 located on an upper end of the sleeve 74 adjacent the first terminal assembly 31. In other embodiments, the sleeve 74 may include more or fewer sealing ridges 134, 138. Illustrated in FIGS. 5 and 7, the first terminal housing 58 includes an outer sealing recess 142 and an inner sealing recess 146 configured to respectively receive the outer sealing ridge 134 and the inner sealing ridge 138. With reference to FIGS. 4 and 5, the first terminal housing 58 includes an outer circumferential lip 150 that receives and surrounds the upper end of the sleeve 74. The sealing ridges 134, 138, the sealing recesses 142, 146, and the lip 150 define a plurality of inter-engaging features that cooperate to form a dielectric seal between the first terminal assembly 31 and the vacuum interrupter assembly 34 upon application of a clamping force by the clamping assembly 110.

With reference to FIG. 4, the sleeve 74 includes a bottom portion 154 extending under a bottom end of the vacuum bottle 62 opposite the first terminal assembly 31 and adjacent the base assembly 38. The bottom portion 154 transitions into a cylindrical sleeve portion 170 that abuts an inner surface of a receiving portion 166 of the base housing 82 to form a dielectric seal between the base housing 82 and the sleeve 74 upon clamping by the clamping assembly 110.

In some embodiments, a method of manufacturing the switchgear system 10 includes providing a vacuum bottle 62 enclosing the fixed contact 66 and the movable contact 70. The movable contact 70 is movable along the first axis A1. The method further includes surrounding the vacuum bottle 62 with the sleeve 74 to form the vacuum interrupter assembly 34. The method further includes providing the first terminal assembly 31 including the conductive lug 54 surrounded by the first terminal housing 58. The conductive lug 54 is electrically connected to the fixed contact 66. The method further includes providing the base assembly 38 including an interchange 78 and the second terminal 40, both electrically connected to the movable contact 70. The interchange 78 and the second terminal 40 are both surrounded by the base housing 82. The method further includes providing the vacuum interrupter assembly 34 such that the vacuum interrupter assembly 34 is operable to selectively break or establish an electrical pathway between the conductive lug 54 and the second terminal 40 in response to movement of the movable contact 70 relative to the fixed contact 66. The method further includes forming the vacuum interrupter assembly 34, the first terminal assembly 31, and the base assembly 38 as separate pieces. The method further includes clamping the vacuum interrupter assembly 34 between the first terminal housing 58 and the base housing 82 to form the loadbreak module 14. The method further includes providing the loadbreak module 14 within the enclosure 26, the enclosure containing atmospheric air.

Because the first terminal assembly 31, the vacuum interrupter assembly 34, and the base assembly 38 are each formed as separate, insulated components, which are subsequently coupled together by the clamping assembly 110, the first terminal assembly 31, the vacuum interrupter assembly 34, and the base assembly 38 may be independently removable and replaceable in the case of, for example, a repair for wear or general maintenance. Alternatively, or additionally, the first terminal assembly 31, the vacuum interrupter assembly 34, or the base assembly 38 may be replaced with another assembly.

For example, with reference to FIG. 12, the first terminal assembly 31 may be replaced with a disconnect switch assembly 214, (which may be also referred to as a third terminal assembly 214). When the first terminal assembly 31 is replaced with the disconnect switch assembly 214, the disconnect switch assembly 214 is operable to selectively open a connection between the fixed contacts 66 and the first conductor 50. Thus, the switchgear system 10 may be provided with or without a disconnect switch assembly 214 while being able to use the same vacuum interrupter assembly 34 and base assembly 38.

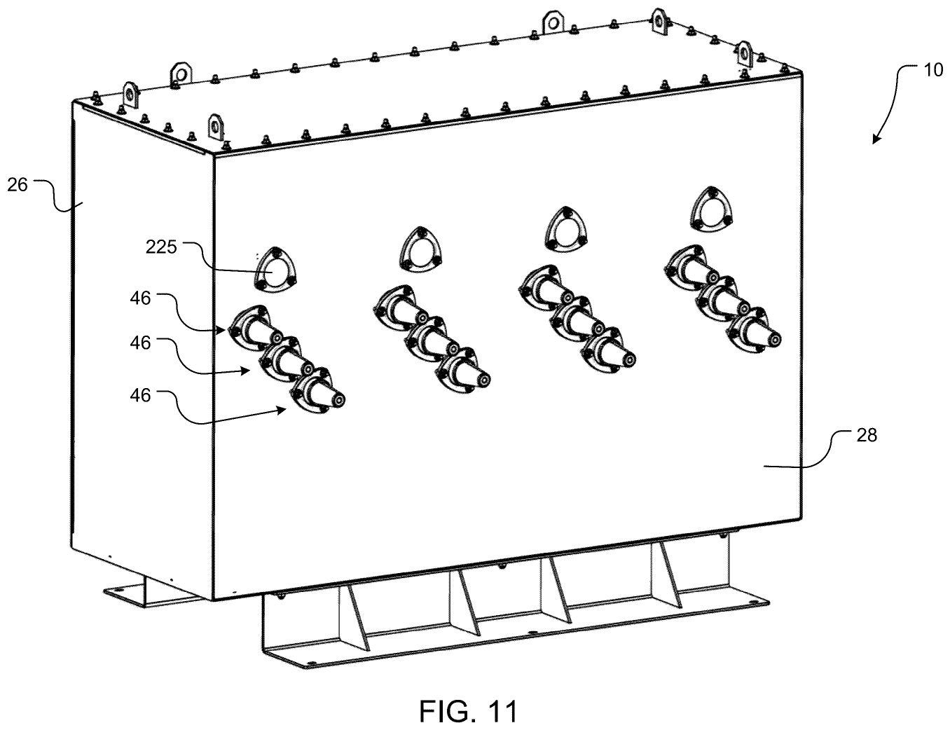

In the illustrated embodiment, the disconnect switch assembly 214 is a three-phase disconnect switch assembly with three terminals 218 (which may be referred to as line terminals) supported by a disconnect switch housing 222. The disconnect switch housing 222 is coupled to each of the three loadbreak modules 14, 18, 22 in a respective way of the switchgear system 10. The first conductors 50 in the illustrated embodiment are configured as bus bars that extend between and interconnect the line terminals 218 across the ways. Thus, because the switchgear system 10 illustrated in FIG. 12 is a four-way system, the switchgear system 10 includes four disconnect switch assemblies 214, all contained within the enclosure 26. With reference to FIG. 11, the enclosure 26 may include a plurality of windows 225 in the front panel 28, generally aligned with the disconnect switch assemblies 214. The windows 225 may allow an operator to visually confirm whether the disconnect switch assemblies 214 are in an open (non-conducting) position or a closed (conducting position).

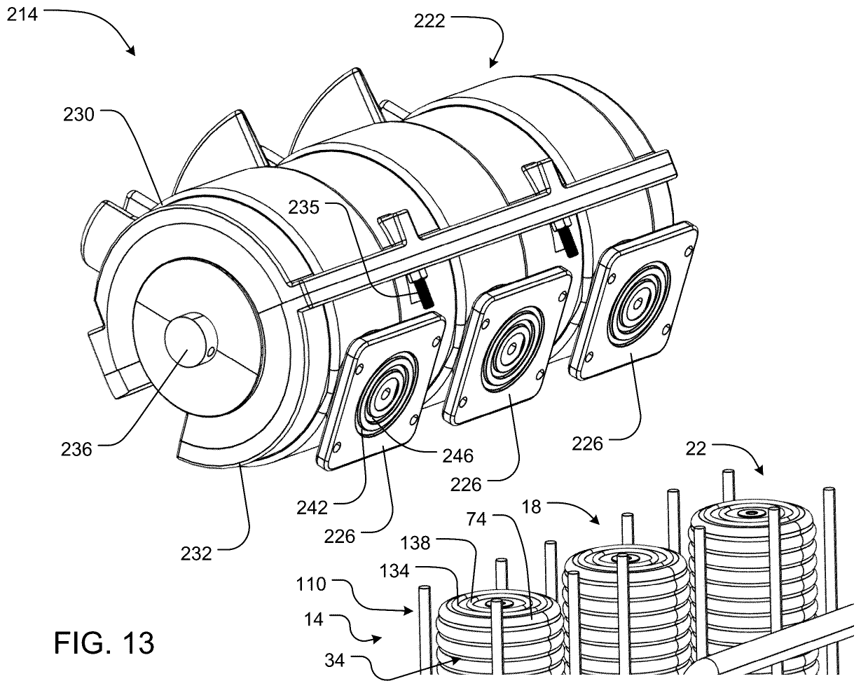

Referring now to FIG. 13, the disconnect switch housing 222 is made of an electrically insulating material (e.g., epoxy resin, polycarbonate, or any other suitable material) and includes first and second housing halves 230, 232 coupled together (e.g., by fasteners 235). The housing halves 230, 232 capture and rotatably support the ends of a rotor 236, described in greater detail below.

In the illustrated embodiment, the second housing half 232 includes three plates 226 (one corresponding with each loadbreak module 14, 18, 22). Similar to the plate 126 described above with reference to FIG. 7, each plate 226 includes an outer sealing recess 242 and an inner sealing recess 246 configured to respectively receive the outer sealing ridge 134 and the inner sealing ridge 138 of the sleeve 74 on the vacuum interrupter assembly 34 of each module 14, 18, 22.

The disconnect switch housing 222 can be clamped to the vacuum interrupter assemblies 34 via the clamping assemblies 110 in generally the same manner as the first terminal housing 58 described above, and the inter-engaging features of the ridges 134, 138 and sealing recesses 242, 246 cooperate to form a dielectric seal between the plates 226 of the disconnect switch housing 222 and the vacuum interrupter assembly 34 upon application of a clamping force by the clamping assemblies 110.

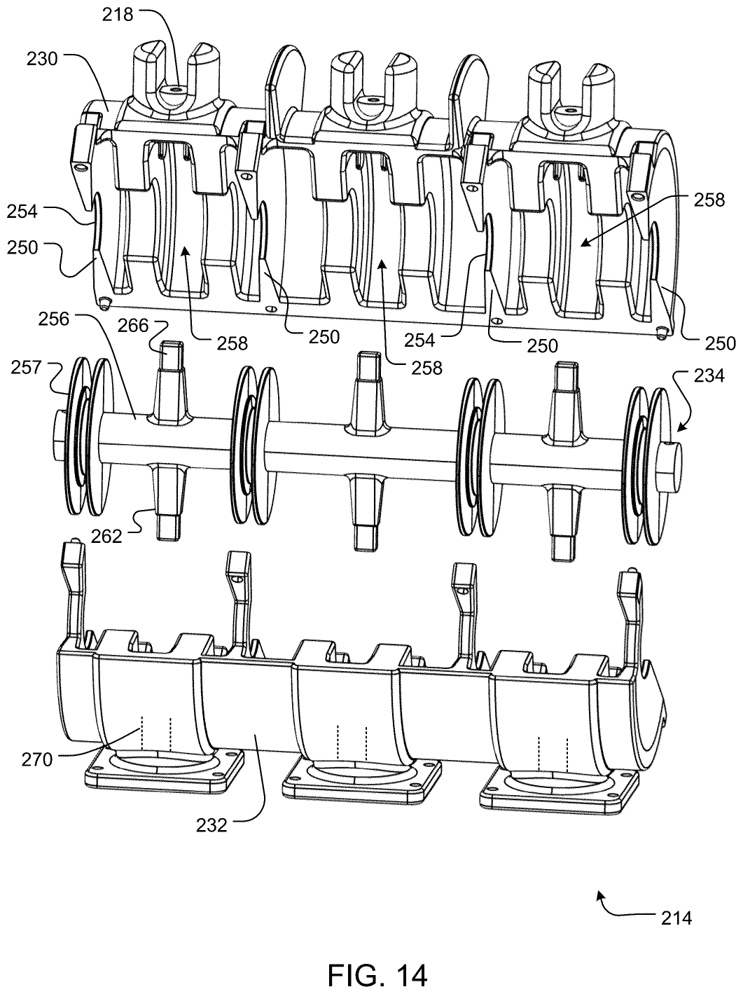

With reference to FIG. 14, each of the housing halves 230, 232 includes a plurality of dividing walls 250, each having a semi-circular recess 254 formed at a center of the dividing wall 250. When the housing halves 230, 232 are assembled, the recesses 254 of the two halves 230, 232 cooperate to form circular bores through which the rotor 234 extends. In the illustrated embodiment, the rotor 234 includes pairs of sheds 257 extending outwardly from a shaft body 256 of the rotor 234. The sheds 257 have a diameter larger than the diameter of each circular bore defined by the recesses 254. When the housing halves 230, 232 are assembled, the dividing walls 250 are sandwiched between the two sheds 257 in each pair. The sheds 257 and dividing walls 250 thus separate the disconnect switch housing 222 into a plurality of (e.g., three) disconnect switch chambers 258 and provide an increased creepage distance between adjacent chambers 258.

With continued reference to FIG. 14, the rotor 234 includes three contact supports 262 extending radially outwardly from the shaft body 256. The contact supports 262 are centered between two pairs of sheds 257. A contact bar 266 through each of the contact supports 262 such that opposite ends of the contact bar 266 are exposed.

The contact bar 266 is engageable with the line terminal 218 at one end and with an input terminal 270 at the opposite end when the rotor 234 is in a first or closed position. The contact bar 266 and terminals 218, 270 for each phase are located within a respective disconnect switch chamber 258. The input terminal 270 is electrically connected to the fixed contact 66 of the associated loadbreak module 14, 18, 22. Thus, when the rotor 234 is in the closed position, the disconnect switch assembly 214 electrically connects the first conductors 50 with the fixed contacts 66.

The rotor 234 (including the shaft body 256, sheds 257, contact supports 262, and contact bar 266) is rotatable to a second or open position, in which the contact bar 266 disengages from the line terminal 218 and the input terminal 270. In the open position, the disconnect switch assembly 214 thus electrically disconnects the fixed contacts 66 from the first conductors 50. In some embodiments, the disconnect switch housing 222 may encase conductive shields, such as the conductive shield 174, positioned around either or both of the line terminal 218 and the input terminal 270 for electrical stress reduction at the respective terminals 218, 270. The rotor 234 may be actuated between the open position and the closed position by a disconnect actuator (not shown), such as the disconnect actuator mechanism described and illustrated in the G & W Application.

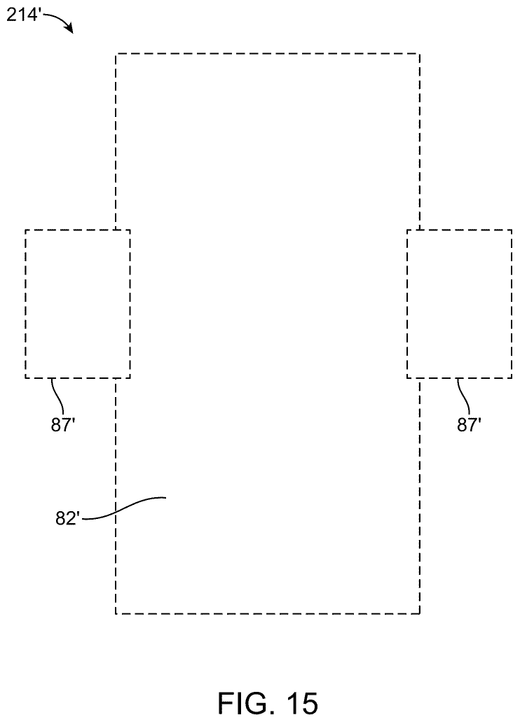

Now referring to FIG. 15, in some embodiments, the base assembly 38 may be replaced with a fourth terminal assembly 214′, illustrated schematically in FIG. 15. In the illustrated embodiment, the fourth terminal assembly 214′ includes a base housing 82′ having two second terminal housings 87′ extending from the base housing 82′ in opposite directions. The second terminal housings 87′ may each enclose a terminal electrically connected to an interchange. The fourth terminal assembly 214′ may therefore be used to provide the switchgear system 10 with additional terminals, while being able to use the same first terminal assembly 31 and vacuum interrupter assembly 34.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A switchgear system comprising:
an enclosure containing atmospheric air; and
a loadbreak module disposed within the enclosure, the loadbreak module including:
a vacuum interrupter having:
a vacuum bottle enclosing a fixed contact and a movable contact, the movable contact movable along a first axis, and
a sleeve surrounding the vacuum bottle,
an interchange surrounded by a base housing, the interchange electrically connected to the movable contact,
a first terminal surrounded by a first terminal housing, the first terminal electrically connected to the fixed contact,
a second terminal electrically connected to the movable contact through the interchange, and
a clamping assembly extending between the base housing and the first terminal housing,
wherein the vacuum interrupter is operable to selectively break or establish an electrical pathway between the first terminal and the second terminal in response to movement of the movable contact relative to the fixed contact,
wherein the vacuum interrupter is clamped between the first terminal housing and the base housing by the clamping assembly.

2. The switchgear system of claim 1, further comprising a first conductor coupled to the first terminal and a second conductor coupled to the second terminal, and wherein the first conductor and the second conductor are each surrounded by insulation.

3. The switchgear system of claim 1, wherein the sleeve includes an outer sealing ridge and an inner sealing ridge, both sealing ridges positioned on an end of the sleeve adjacent the first terminal.

4. The switchgear system of claim 1, wherein the sleeve is made of a resilient insulating material overmolded on the vacuum bottle.

5. The switchgear system of claim 4, wherein the sleeve is compressed between the first terminal housing and the base housing.

6. The switchgear system of claim 4, wherein the sleeve includes a plurality of external circumferential ribs.

7. The switchgear system of claim 1, wherein the first terminal housing is made of a molded solid dielectric material.

8. The switchgear system of claim 1, wherein the base housing is made of a molded solid dielectric material.

9. The switchgear system of claim 1, wherein the clamping assembly includes a plurality of clamping members extending between the first terminal housing and the base housing, the clamping members applying a force to the first terminal housing and to the base housing to compress the sleeve between the first terminal housing and the base housing to form a first dielectric seal between the first terminal housing and the sleeve and to form a second dielectric seal between the base housing and the sleeve.

10. The switchgear system of claim 9, wherein each clamping member includes a threaded stud made of fiberglass.

11. A three-phase switchgear system comprising the switchgear system of claim 1, wherein the loadbreak module is a first loadbreak module, and wherein the three-phase switchgear system further comprises:
a second loadbreak module identical to the first loadbreak module corresponding to a second phase of the three-phase switchgear system; and
a third loadbreak module identical to the first loadbreak module corresponding to a third phase of the three-phase switchgear system,
wherein the first, second, and third loadbreak modules are disposed within the enclosure.

12. The switchgear system of claim 1, wherein a first terminal assembly includes the first terminal and the first terminal housing, and wherein the first terminal assembly is interchangeable with a disconnect switch assembly.

13. A switchgear system for a power distribution system, the switchgear system comprising:
a vacuum interrupter including an insulating sleeve and a vacuum bottle surrounded by the sleeve, the vacuum bottle enclosing a fixed contact and a movable contact;
a first terminal assembly including a first terminal configured to be electrically connected to the fixed contact and a first terminal housing made of a molded solid dielectric material, the first terminal surrounded by the first terminal housing; and
a base assembly including a base housing made of a molded solid dielectric material, an interchange supported within the base housing and configured to be electrically connected to the movable contact, and a second terminal electrically connected to the interchange;
wherein the vacuum interrupter is operable to selectively break or establish an electrical pathway between the first terminal and the second terminal in response to movement of the movable contact relative to the fixed contact; and
a disconnect switch assembly configured to be modularly interchangeable with the first terminal assembly.

14. The switchgear system of claim 13, wherein the first terminal assembly, the vacuum interrupter, and the second terminal assembly are clamped together to provide a first dielectric seal between the first terminal housing and the sleeve and to provide a second dielectric seal between the second terminal housing and the sleeve.

15. The switchgear system of claim 13, wherein the disconnect switch assembly, the vacuum interrupter, and the second terminal assembly are clamped together to provide a first dielectric seal between the disconnect switch assembly and the sleeve and to provide a second dielectric seal between the second terminal housing and the sleeve.

16. The switchgear system of claim 13, wherein the disconnect switch assembly includes a housing, a rotor supported by the housing and including a contact bar, a line terminal, and an input terminal opposite the line terminal, wherein the input terminal is configured to be electrically connected to the fixed contact, and wherein the rotor is rotatable between a closed position, in which the contact bar electrically connects the line terminal and the input terminal, and an open position, in which the line terminal and the input terminal are electrically disconnected.

17. The switchgear system of claim 16, wherein the housing of the disconnect switch assembly includes a plurality of dividing walls each sandwiched between a pair of sheds extending from a shaft portion of the rotor.

18. A method of manufacturing a switchgear system, the method comprising:
providing a vacuum bottle enclosing a fixed contact and a movable contact, the movable contact movable along a first axis;
surrounding the vacuum bottle with a sleeve to form a vacuum interrupter assembly;
providing a first terminal assembly including a first terminal surrounded by a first terminal housing, the first terminal electrically connected to the fixed contact;
providing a base assembly including an interchange and a second terminal both electrically connected to the movable contact, the interchange and the second terminal both surrounded by a base housing; and
clamping the vacuum interrupter assembly between the first terminal housing and the base housing to form a loadbreak module.

19. The method of claim 18, wherein surrounding the vacuum bottle with the sleeve includes overmolding the sleeve on the vacuum bottle.

20. The method of claim 18, wherein the sleeve is made of a resilient insulating material.
